(19) United States
(12) Patent Application Publication
(10) Pub. No.: US 2005/0282021 A1
(43) Pub. Date: Dec. 22, 2005

(54) Composition for forming coating film comprising carbosilane based polymer and coating film obtained from the composition

(76) Inventors: Naoki Yamashita, Kanagawa (JP); Yoshinori Sakamoto, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/135,342

(22) Filed: May 24, 2005

(30) Foreign Application Priority Data
Jun. 21, 2004 (JP) 2004-182999

(51) Int. Cl. B32B 9/04

(52) U.S. Cl. 428/446

(57) ABSTRACT

The present invention provides a composition for forming a coating film comprising a carbosilane based polymer, and a coating film obtained from the composition. The composition for forming a coating film comprises: a carbosilane based polymer (A) having a repeating unit represented by the following general formula (1): 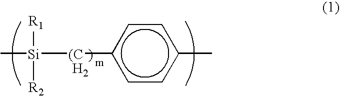
wherein R₁ and R₂ are each independently hydrogen or alkyl groups having 1 to 20 carbon atoms and m is an integer of 0 to 20; and a solvent (B). The coating film according to the present invention is obtained by curing a coating layer formed from the composition for forming a coating film.

### BACKGROUND OF THE INVENTION

This application is based upon and claims the benefit of priority from Japanese Patent Application No. 2004-182999, filed Jun. 21, 2004, the entire contents of which are incorporated herein by reference.

1. Field of the Invention

The present invention relates to a composition for forming a coating film comprising a carbosilane based polymer, and a coating film obtained from the composition. More particularly, the present invention relates to a composition for forming a coating film comprising a carbosilane based polymer, and a coating film obtained from the composition which is preferably applicable to form an etching stopper layer and an interlayer insulating layer in forming multilayer wiring of a semiconductor device.

2. Description of the Related Art

As well-known, in a basic wiring structure of a semiconductor integrated circuit, a lower wiring layer formed directly or indirectly on a semiconductor substrate and an upper wiring layer formed on the lower wiring layer through an interlayer insulating layer are connected by a via wiring formed to penetrate the interlayer insulating layer. A multilayer wiring structure of the semiconductor integrated circuit is formed by complexifying the wiring structure and multiplying a layer of the wiring structure.

Conventionally, this wiring structure is fulfilled by repeatedly forming layers such as a conductor layer and an interlayer insulating layer laminated on the semiconductor substrate and patterning the layers by etching alternatively. In such a sequential formation method for forming a multilayer wiring by repeatedly laminating and etching, the formation method accompanies many steps and it is difficult to reduce a production cost. Therefore, at present, an inlaid process generally referred to as a damascene process is employed. In this damascene process, a via hole for forming the via wiring and the upper wiring layer and a wiring groove referred to as a trench are formed in the interlayer insulating layer, and then spaces in the via hole and the trench are plugged by conductor materials.

A method for forming the via wiring and the upper wiring layer simultaneously in this damascene process is referred to as a dual damascene process. By employing this damascene process, it has become possible to use copper which could not be used conventionally as a conductor material. The copper is preferable conductor material for a fine wiring compared with aluminum because a tolerance property to an electro migration of the copper is superior to that of the aluminum. In this dual damascene process, the via wiring and the trench wiring may be formed simultaneously, and thus the production cost of a semiconductor device may be reduced. Therefore, the dual damascene process is spreading generally.

Currently, for further miniaturizing the size of a semiconductor device, materials having high characteristic properties are being developed in not only wiring materials but also the interlayer insulating layer which surrounds the wiring layer. For the interlayer insulating layer, a low dielectric constant property is first required, and additionally physical properties such as heat resistance, anti-cracking and film formation properties are required. The materials excellent in such properties are investigating. For example, a composition for improving the physical properties such as low dielectric constant property, heat resistance and anti-cracking property required for the interlayer insulating layer has been proposed (refer to Patent Documents 1 and 2). Patent Document 1: Japanese Patent Laid-Open No. 2003-77908 A Patent Document 2: Japanese Patent Laid-Open No. 2003-297820 A

### SUMMARY OF THE INVENTION

In the aforementioned semiconductor wiring formation, a coating film layer is also used at varieties aspects in addition to the interlayer insulating layer. The coating film layer allows to efficiently promote the wiring formation of the semiconductor, minimize the obtained wiring and increase quality thereof. Such a coating film layer may include an interlayer insulating layer in which a trench wiring and a via wiring which are wiring layers are formed inside, an etching stopper layer provided between a lower interlayer insulating layer and an upper interlayer insulating layer when trench and via wiring formation space is formed by etching, a cover film for protecting the formed wiring layer, and a planarizing layer for planarizing a laminated surface by forming on a non-flat layer such as a pattern wiring layer.

For coating film layers including the interlayer insulating layer, a low dielectric constant is needed because the coating film layer is required to fulfill a role to insulate between wiring layers. When the coating film layer is used for the etching stopper layer, a durability to etching must be high. Further, in order to make a pattern to the wiring layer, a resist layer formed on the coating film layer is used. However, in these coating film layers, exposed light used during exposing the resist layer is reflected, and a favorable pattern can not be formed on the resist layer. Therefore, a property to prevent (absorb) the reflection of the exposed light is sometimes required for the coating film layer. Recently in particular, along with miniaturization of semiconductor devices, a wavelength of the exposed light has been shortened. For example, it appears that it is important to prevent the reflection of the light with a short wave length of about 193 nm.

In prior art as a representative of the Patent Documents 1 and 2, it has been considered to improve the low dielectric constant property, the heat resistance, mechanical strength, and low thermal expansion property. However, properties in consideration of the patterning such as etching resistance and anti-reflective capability (absorption capability) for short wavelength light have not been improved. As described above, in addition to the interlayer insulating layer, a plurality kinds of coating film layers such as an etching stopper layer, a planarizing layer and a covering layer are needed for the formation of the semiconductor wiring. For these layers, a low dielectric constant property, an anti-reflective capability for the short wavelength light, a durability to etching and smoothness are commonly required for the present situation. However, in the prior art, no coating film forming material which simultaneously satisfies these properties has been provided.

The present invention has been made in the light of the above circumstance, and an object of the present invention is to provide a composition for forming a coating film suitable for forming a coating film used for semiconductor wiring formation, and a coating film obtained by using the composition.

In order to solve the above problems, the present inventors have extensively studied on a composition for forming a coating film which is excellent in low dielectric constant property, heat resistance and anti-reflective capability for the short wavelength light, and consequently found that a composition for forming a coating film comprising a novel carbosilane based polymer having a repeating unit represented by the following general formula (1) meets the aforementioned requirements. 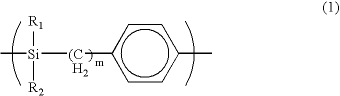
wherein, R₁ and R₂ are each independently hydrogen or alkyl groups having 1 to 20 carbon atoms, and m is an integer of 0 to 20.

That is, the composition for forming a coating film according to the present invention contains at least a carbosilane based polymer (A) having a repeating unit represented by the above formula (1) and a solvent (B).

The coating film according to the present invention is obtained by curing a coating layer formed from the aforementioned composition for forming a coating film.

The composition for forming a coating film including the carbosilane based polymer according to the present invention is particularly excellent in anti-reflective capability for short wavelength light, has a low dielectric constant and is also excellent in a durability to etching, when formed into a coating film. Therefore, the composition containing at least the carbosilane based polymer and the solvent may be used suitably when a fine semiconductor wiring is formed.

### DETAILED DESCRIPTION OF THE PREFERRED EMBODIMENTS

Embodiments of the present invention will be explained below.

As described above, the composition for forming a coating film according to the present invention comprises a carbosilane based polymer (A) having a repeating unit represented by the above general formula (1) and a solvent (B).

In the above general formula (1), it is preferable that R₁ and R₂ are different from one another. Because different R₁ and R₂ may control a solubility of the polymer (1) to the solvent (B). Preferable combination between R₁ and R₂ is a combination where a difference in numbers of carbon atoms between R₁ and R₂ is two or more. It is also preferable that at least one of R₁ and R₂ has 10 or less of carbon atoms. Preferable examples in the combination of R₁ and R₂ are a methyl group and a propyl group.

Such a combination may control the solubility of the polymer (A) to the solvent (B), for example, which may control the solubility of 1 to 2% by weight to that of about 10 to 40% by weight. The solubility of the polymer (A) to the solvent (B) is preferably 0.5 to 50% by weight, and more preferably 1 to 20% by weight.

A thickness of the coating film formed from the composition for forming a coating film is similar to that of a conventional film and can not be completely defined depends on an intended use, but is 10 nm or more and 1000 nm or less, preferably 100 nm or more and 500 nm or less, and more preferably 300 nm or less.

A polymer concentration in the composition for forming a coating film may be controlled by controlling the solubility of the polymer (A) to the solvent (B) as described above. The thickness of the coating film formed is easily controlled by this polymer concentration.

When a value of “m” in the above general formula (1) is too large, a number of benzene rings is reduced, and thus an absorption amount of light at around 193 nm is decreased. The particularly preferable value of “m” is 0.

The carbosilane based polymer (A) used for the composition of the present invention suitably has a weight-average molecular weight in the range of 1,000 to 10,000. Because it is easy to assure a film formation property and flatness of the film, and durability to etching is also excellent in such a carbosilane based polymer. In particular, when the molecular weight is too small, the carbosilane based polymer (A) is vaporized, and it is unlikely to be formed into a film.

The solvent (B) used for the present invention may include monohydric alcohols such as methyl alcohol, ethyl alcohol, propyl alcohol and butyl alcohol; polyhydric alcohols such as ethylene glycol, diethylene glycol, propylene glycol, glycerine, trimethylolpropane and hexanetriol; monoethers of polyhydric alcohols such as ethylene glycolmonomethylether, ethylene glycolmonoethylether, ethylene glycolmonopropylether, ethylene glycolmonobutylether, diethylene glycolmonomethylether, diethylene glycolmonoethylether, diethylene glycolmonopropylether, diethylene glycolmonobutylether, propylene glycolmonomethylether, propylene glycolmonoethylether, propylene glycolmonopropylether and propylene glycolmonobutylether; esters such as methyl acetate, ethyl acetate and butyl acetate; ketones such as acetone, methylethylketone, cycloalkylketone and methylisoamylketone; polyhydric alcohol ethers where all hydroxyl groups of polyhydric alcohols are alkyl-etherified, such as ethylene glycoldimethylether, ethylene glycoldiethylether, ethylene glycoldipropylether, ethylene glycoldibutylether, propylene glycoldimethylether (PGDM), propylene glycoldiethylether, propylene glycoldibutylether, diethylene glycoldimethylether, diethylene glycolmethylethylether and diethylene glycoldiethylether. Among these solvents, cycloalkyl ketone and alkylene glycoldialkylether are more preferable. Furthermore, as alkylene glycoldimethylether, PGDM (propylene glycoldimethylether) is preferable. These organic solvents may be used alone, or a combination of two or more of these solvents may also be used. An appropriate mixing amount of the solvents is 70 to 99% by weight.

In the composition according to the present invention, a low dielectric polymer such as polyarylene ether which is conventionally and commonly used may be mixed to use as another polymer in addition to the carbosilane based polymer (A). In that case, it is necessary to mix another polymer at an amount in the range where the anti-reflecting capability for short wavelength light of the composition may be within an extent of a practical use after mixing. An etching rate may be controlled by a mixing ratio of this conventional low dielectric polymer, and thereby it is possible to use the composition according to the present invention as not only an etching stopper layer with high durability to etching but also an interlayer insulating layer which requires a relatively high etching rate. A siloxane polymer such as a hydrolyzed and/or condensed alkoxysilane may be mixed.

The composition according to the present invention is provided as a coating solution by the solvent, and applied on a predetermined layer or a substrate depending on a purpose, subsequently heated, dried and baked to form a coating film. An application of the coating solution may be performed by using an arbitrary method such as a spray, spin coating, dip coating and roll coating methods.

By using the composition for forming a coating film according to the present invention, various types of coating films such as an interlayer insulating layer and an etching stopper layer may be formed. Each coating film is optimized by appropriately controlling conditions such as a drying temperature in the film formation.

Taking an example, when an interlayer insulating film is formed, the layer is heated on a hot plate at about 80 to 300° C. for about 1 to 6 minutes. It is preferable to raise the temperature in stages, preferably three stages or more. Specifically, a first drying treatment is performed on the hot plate at about 70 to 120° C. for about 30 seconds to 2 minutes in air or in an atmosphere of an inert gas such as nitrogen, then a second drying treatment is performed at about 130 to 220° C. for about 30 seconds to 2 minutes, and further a third drying treatment is performed at about 150 to 300° C. for about 30 seconds to 2 minutes. Thus, the surface of the coating layer may be made uniform by performing the drying treatment in stages, three stages or more, preferably 3 to 6 stages.

The coating layer performed the drying treatment is subsequently performed a baking treatment. The baking treatment is performed at a temperature of about 300 to 400° C. in a nitrogen atmosphere. In cases where the baking temperature is less than 300° C., a durability to etching is likely to be insufficient when the coating film is the etching stopper layer. Meanwhile when the baking temperature is more than 400° C., the dielectric constant, which is required to be kept low, in the various types of coating films is unlikely to be kept low.

In accordance with a method for forming a coating film as mentioned above, various types of coating films having low dielectric constant property such that the dielectric constant is 0.3 or less, excellent durability to etching and anti-reflecting capability for the short wavelength light may be formed.

### EXAMPLES

Examples of the present invention will be explained below. The examples shown below are only exemplifications for preferably illustrating the invention, and it is not intended to limit the present invention to the examples described below.

### Example 1

In the present Example, a carbosilane based polymer (A1) having a repeating unit represented by the following chemical formula (2) was used.

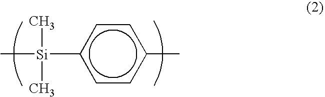

1.0 g of the polymer (A1) was added to 99.0 g of cyclopentanone and dissolved by means of an ultrasonic device for 2 hours, thereby obtaining a coating solution (composition for forming a coating film) at a concentration of 1% by weight having a molecular weight of 3,000 to 8,000 for its solid content.

Using the obtained coating solution, a coating film was formed by the following method for forming a coating film. A film thickness of the resulting coating film was 35 nm. Subsequently, an etching rate (angstroms/min), a dielectric constant, an absorbance of light with a wavelength of 193 nm, and surface smoothness of the coating film were evaluated. The results are shown in the following Table 1.

[Method for Forming a Coating Film]

The coating solution for forming a coating film was applied on a silicon wafer by a spin coating method, and heated at 80° C. for 1 minute on a hot plate in air. Then, the coating layer was heated at 150° C. for 1 minute, and further at 200° C. for 1 minute (drying treatment)

Thereafter, a treatment with heat at 350° C. was performed for 30 minutes in a nitrogen atmosphere (baking treatment), thereby obtaining a coating film.

[Method for Measuring Dry Etching Rate]

A dry etching was performed to the resulting coating film, a film thickness change performed before and after the dry etching was measured using a spectroscopic ellipsometer (supplied from Mizojiri Optical Co., Ltd., measured wavelength: 633 nm), and a durability to dry etching was evaluated from the measured film thickness change.

The aforementioned dry etching was performed as follows. The dry etching was performed under a condition at a power of 400 W and a pressure of 300 mTorr for 30 seconds using an oxide film etcher (product name: TCE7612-XX supplied from Tokyo Ohka Kogyo Co., Ltd.) composed of the following composition of (1), (2) and (3):
(1) CF₄/CHF₃=20/30, He:100 (cc/min),
(2) CF₄/CHF₃=25/25, He:100 (cc/min), and
(3) CF₄/CHF₃=30/20, He:100 (cc/min).

[Method for Measuring Dielectric Constant]

A relative dielectric constant of the obtained coating film in a direction of a film thickness was measured relative to vacuum using a dielectric constant measurement apparatus SSM495 (supplied from SSM Japan K.K.).

[Method for Measuring Absorbance of Light with Wavelength of 193 nm]

An absorbance at 193 nm was measured using a spectroscopic ellipsometer “VUV-VASE” (supplied from J. A. Woollam, measured wavelength: 193 nm).

[Method for Measuring Surface Smoothness]

The film thickness was measured at 9 points on a coating layer using the spectroscopic ellipsometer “DHA-XA2” (supplied from Mizojiri Optical Co., Ltd., measured wavelength: 633 nm), and a surface smoothness was evaluated from an average distribution (± %) of the measured film thickness.

### Example 2

In the present Example, a carbosilane based polymer (A2) having the repeating unit represented by the following chemical formula (3) was used.

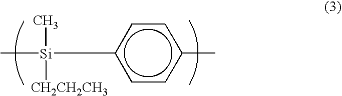

1.0 g of the polymer (A2) was added to 99.0 g of cyclopentanone, and dissolved by means of an ultrasonic device for 2 hours, thereby obtaining a coating solution (composition for forming a coating film) at a concentration of 1% by weight having a solid molecular weight of 3,000 to 8,000 for its solid content.

Using the obtained coating solution, a coating film was formed by the aforementioned method for forming a coating film. Subsequently, as in the same manner in Example 1, an etching rate (angstroms/min), a dielectric constant, an absorbance of light with a wavelength of 193 nm, a durability to cracking and a surface smoothness of the resulting coating film were evaluated. The results are shown in the following Table 1.

### Comparative Example 1

A coating film was formed by using a composition for forming a coating film comprising methylsilsesquioxane as a major constituent polymer (product name: OCD T-11, supplied from Tokyo Ohka Kogyo Co., Ltd.) as a coating solution.

Using this coating solution, a coating film was formed by the aforementioned method for forming a coating film.

As in the same way in Example 1, an etching rate (angstroms/min), a dielectric constant, an absorbance of the light with a wavelength of 193 nm, a durability to cracking and a surface smoothness of the resulting coating film were evaluated. The results are shown in the following Table 1.

### Comparative Example 2

A coating film was formed by using a composition for forming a coating film comprising hydroxysilsesquioxane as a major constituent polymer (product name: OCD T-12, supplied from Tokyo Ohka Kogyo Co., Ltd.) as a coating solution by the aforementioned method for forming a coating film.

As in the same way in Example 1, an etching rate (angstroms/min), a dielectric constant, an absorbance of the light with a wavelength of 193 nm, a durability to cracking and a surface smoothness of the resulting coating film were evaluated. The results are shown in the following Table 1.

TABLE 1

| | Etching rate | | | | | |
|---|---|---|---|---|---|---|
| | (angstroms/min) | | | | | |
| | Gas | Gas | Gas | Dielectric | Absorb- | Smoothness |
| | (1) | (2) | (3) | Constant | ance | (±%) |
| Example 1 | 128 | 242 | 376 | 2.8 | 0.6 | 2 |
| Example 2 | 144 | 252 | 391 | 2.8 | 0.6 | 2 |
| Comparative | 396 | 679 | 1012 | 3.4 | 0 | 3 |
| Example 1 | | | | | | |
| Comparative | 1302 | 3262 | 3848 | 3.0 | 0 | 1 |
| Example 2 | | | | | | |

From Examples 1 and 2, it is shown that the coating film formed from the composition for forming a coating film according to the present invention may be sufficiently applicable as an interlayer insulating film because the dielectric constant is low and the smoothness is favorable. The coating film may also be used as an etching stopper layer because the durability to etching is shown to be high from the results of the etching rate. Further, the coating film absorbed the light at 193 nm, thereby indicating that reflection of the light with short wavelength can be prevented.

As illustrated in the above, in the composition containing at least the carbosilane based polymer according to the present invention and the solvent, a anti-reflecting capability for the short wavelength light is excellent. When formed into a coating film from the composition, a dielectric constant is low and a durability to etching is high. Therefore, the composition according to the present invention may be used preferably when the fine semiconductor wiring is formed.

1. A composition for forming a coating film comprising:
a carbosilane based polymer (A) having a repeating unit represented by the following general formula (1): 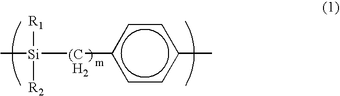
wherein R₁ and R₂ are each independently hydrogen or alkyl groups having 1 to 20 carbon atoms and m is an integer of 0 to 20; and
a solvent (B).

2. The composition for forming a coating film according to claim 1, wherein R₁ and R₂ in the general formula (1) are different from each other.

3. The composition for forming a coating film according to claim 1, wherein a difference in carbon numbers between R₁ and R₂ in the general formula (1) is 2 or more.

4. The composition for forming a coating film according to claim 1, wherein a weight-average molecular weight of the carbosilane based polymer (A) is 1,000 to 10,000.

5. The composition for forming a coating film according to claim 1, wherein the solvent (B) comprises cycloalkyl ketone or alkylene glycoldialkylether.

6. A coating film obtained by curing a coating layer formed from a composition for forming a coating film, wherein the composition comprises:
a carbosilane based polymer (A) having a repeating unit represented by the following general formula (1): 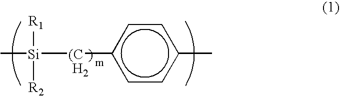
wherein R₁ and R₂ are each independently hydrogen or alkyl groups having 1 to 20 carbon atoms and m is an integer of 0 to 20; and
a solvent (B).

7. The coating film according to claim 6, wherein the coating film is an etching stopper layer provided between interlayer insulating layers in a step of forming a semiconductor wiring.

8. The film according to claim 6, wherein the coating film is an interlayer insulating layer, inside of which a wiring layer is formed in a step of forming a semiconductor wiring.
